(19) United States
(12) Patent Application Publication
(10) Pub. No.: US 2010/0065371 A1
(43) Pub. Date: Mar. 18, 2010

(54) Tree stand protection system

(76) Inventor: Paul F. Glenn, Egg Harbor City, NJ (US)

Correspondence Address: Hollstein Keating Cattell Johnson & Goldstein PC;Willow Ridge Executive Office Park, Suite 301, 750 Rt. 73 S., Marlton, NJ, 08053, US

(21) Appl. No.: 12/284,075

(22) Filed: Sep. 17, 2008

(51) Int. Cl. A01M 31/02; E05B 73/00

(52) U.S. Cl. 182/187; 70/62; 248/553

(57) ABSTRACT

A tree stand protection system has an elongated primary bar member which extends from the platform of the existing tree stand upwards to the tree on which the stand is supported. The bar member is attached to and locked at its upper end to the tree and at its lower end to the platform. The bar member and strategically placed cross-bar and auxiliary bar members make standing and sitting on the tree stand difficult, if not impossible. It generally accomplishes the objective of restricting the movement, activity, and vision of an unauthorized user on the tree stand, effectively preventing hunting from the stand.

### BACKGROUND OF THE INVENTION

The use of tree stands, positioned on trees at heights well above the ground, is a common practice for hunters seeking to obtain an elevated vantage point in prime hunting locations. Such stands are routinely installed in or on trees in an especially favorable location and, as a result are often left in place after the day's hunting is completed. Since it is sometimes difficult and cumbersome to move tree stands from tree to tree, hunters will also routinely leave their tree stands in position on the trees and return to that location in the future.

However, in leaving a tree stand unattended, the owner takes the risk of the unauthorized use of the stand. Protecting the unattended tree stand from this improper use is an objective which has yet to be addressed. There currently are no effective means to prevent hunters from positioning themselves on unoccupied tree stands without the permission or knowledge of the owner, and from using and abusing the stands.

### SUMMARY OF THE INVENTION

It is thus the object of the present invention to provide a tree stand protection system which addresses the need for preventing the unauthorized use of a tree supported tree stand. The invention provides a system which, once installed on the tree, will restrict the movement, activity, and vision of the individual who attempts to hunt from the stand. The present invention provides a system which is easily installed on an existing tree stand, is effective in preventing hunting activity from the stand, and is easily removeable by the authorized user of the stand to allow hunting activity.

The tree stand protection system of the present invention comprises an elongated primary bar member which extends from the platform of the existing tree stand upwards to the tree on which the stand is supported. The bar member is attached to and locked at its upper end to the tree and at its lower end to the platform. The bar member and strategically placed cross-bar and auxiliary bar members make standing and sitting on the tree stand difficult, if not impossible. It generally accomplishes the objective of restricting the movement, activity, and vision of an unauthorized user on the tree stand, effectively preventing hunting from the stand.

The novel features which are considered as characteristic of the invention are set forth in particular in the appended claims. The invention, itself, however, both as to its design, construction and use, together with additional features and advantages thereof, are best understood, upon review of the following detailed description with reference to the accompanying drawings.

### BRIEF DESCRIPTION OF THE DRAWINGS

FIG. 1 is an isometric view of the tree stand protection system of the present invention, as positioned on a tree.

FIG. 2 is an isometric view of a second embodiment of the tree stand protection system of the present invention, as positioned on a tree.

FIG. 3 is an elevation view of the tree stand protection system of the present invention, as positioned on a tree.

FIG. 4 is an isometric view of the lower end of the tree stand protection system of the present invention.

### DETAILED DESCRIPTION OF THE INVENTION

The tree stand protection system 1 of the present invention prevents the use of tree stand 4, supported on tree 2 by straps, chains, or other commonly employed tree attachment means 3. Tree stand 4 comprises standard user supporting platform 6 and seat rest 8.

The tree stand protection system 1 is designed to be removeably attached to tree 2 and platform 6, forming a barrier for restricting the use of tree stand 4. The system comprises elongated bar member 12 which, when in place, extends from platform 6 upward to tree 2, to a location well above tree stand 4 in position on the tree. Bar member 12 comprises a substantially straight primary section 14 which curves into upper shorter section 16. Second bar member 18 extends diagonally from bar member 12 and cross-bars 20 and 22 are positioned across the second bar member. Auxiliary bar member 24 extends up from section 16 of bar member 12.

Locking pad 26 extends down from the end of section 16 of bar member 12. Locking pad 26 is configured to be inserted through an opening in tree locking cleat 28. Locking cleat 28 is to be screwed into or otherwise secured to the outside of tree 2. Locking pad 26 also comprises through opening 32 into which padlock 34 can be secured.

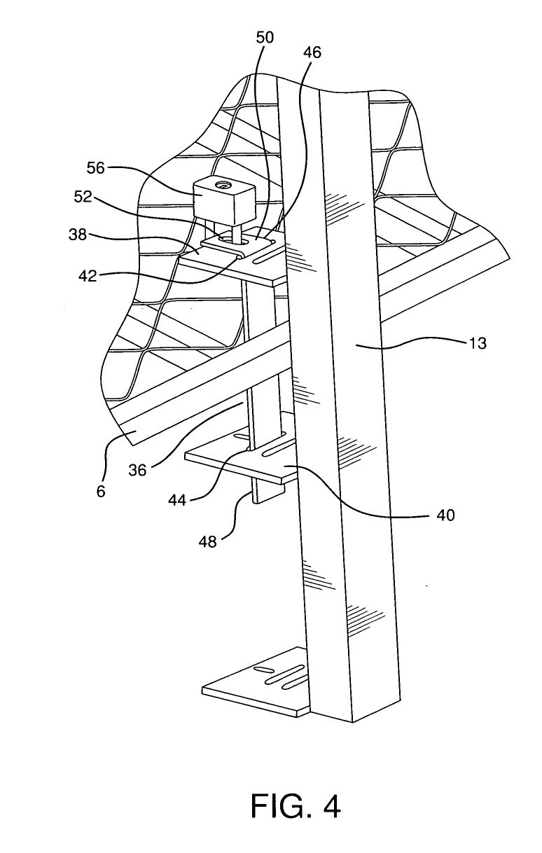

As best seen in FIG. 4, locking clasp system 36 is located at the foot or lower end of section 13 of bar member 12. Clasp system 36 comprises upper plate 38 and lower plate 40 secured to and extending horizontally from bar member 12. Plates 38 and 40 have openings 42 and 44, respectively. Clasp system 36 also comprises locking plate 46 having vertical section 48 and horizontal section 50. Vertical section 48 is configured to extend through openings 42 and 44 in plates 38 and 40. Horizontal section 50 is configured to line up over upper plate 38. Horizontal section 50 has through hole 52. Upper plate 38 has a through hole aligned with through hole 52 of horizontal section 50 of locking plate 46. The through hole in upper plate 38 is hidden by horizontal section 50 in FIG. 4. When locking plate 46 is inserted into openings 42 and 44 of plates 38 and 40, hole 52 and the upper plate through hole are aligned for receiving padlock 56.

In use, primary section 14 of bar member 12 is positioned over supporting platform 6 and upper section 16 of the bar member is positioned against tree 2. Upper plate 38 of locking clasp 36 is positioned over supporting platform 6 of tree stand 4 and lower plate 40 is positioned under the supporting platform 6. Vertical section 48 of locking plate 46 is then inserted through openings 42 and 44 in upper plates 38 and lower 40, such that hole 52 of horizontal section 50 of the locking plate is aligned with the through hole of upper plate 38. Padlock 56 is then inserted through hole 52 and the upper plate hole, thus securing primary section 14 of bar member 12 to platform 6.

Locking pad 26 is next inserted through the opening in locking cleat 28. Padlock 34 is inserted through opening 32 in locking pad 26, securing upper section 16 of bar member 12 to tree 2. Bar member 12, extending from platform 6 to tree 4, is thus fully secured and locked in position.

When the tree stand protection system 1 is in place in the fully secured and locked position, use of tree stand 4 will be severely restricted, if not impossible. Cross-bars 20 and 22 prevent unencumbered sitting on seat rest 8 or standing on platform 6, on either side of tree stand 4. Auxiliary bar member 24 prevents sitting on upper section 16 of bar member 12. The presence of bar member 12 itself, also restricts movement and activity on tree stand 4 and, additionally, serves to block the vision of an unauthorized user.

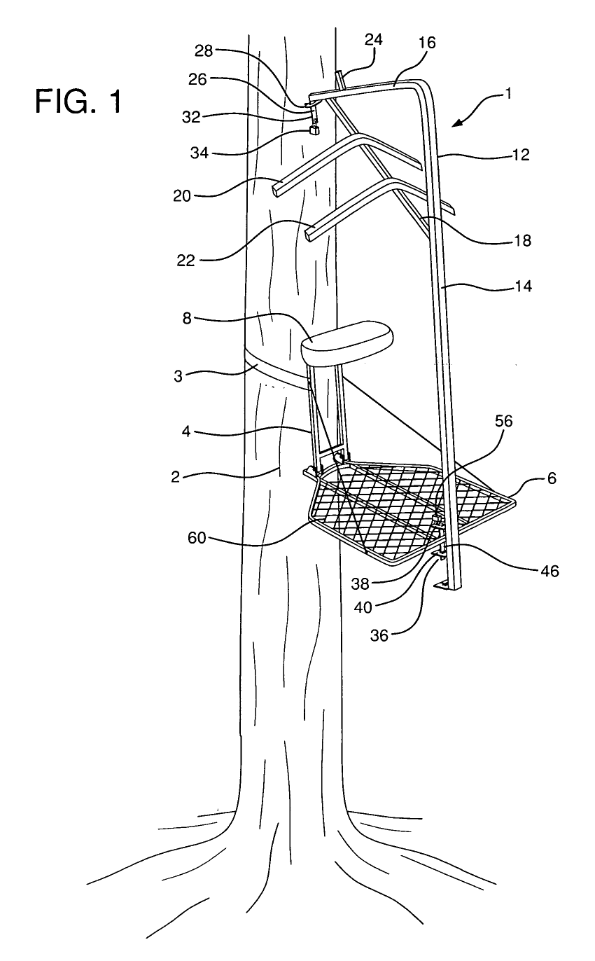

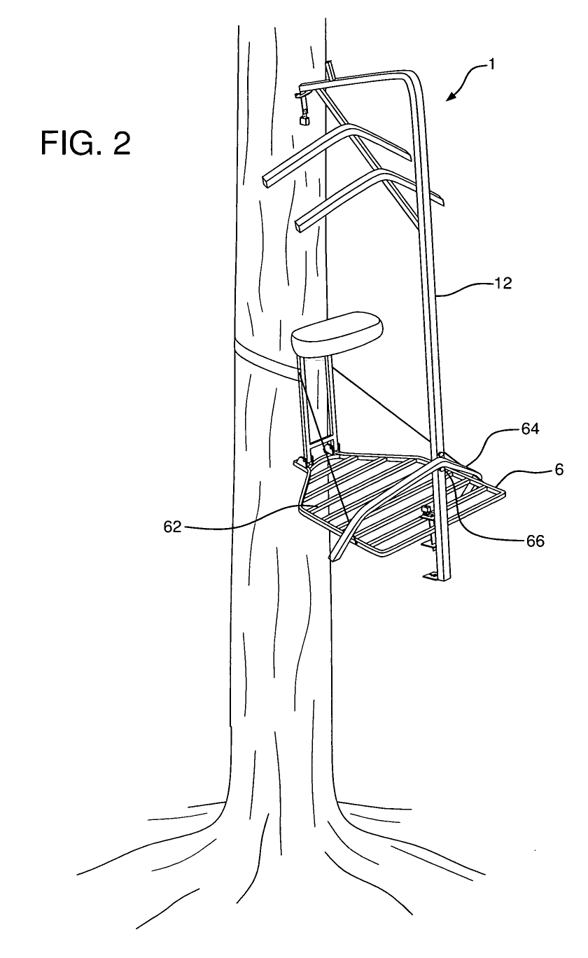

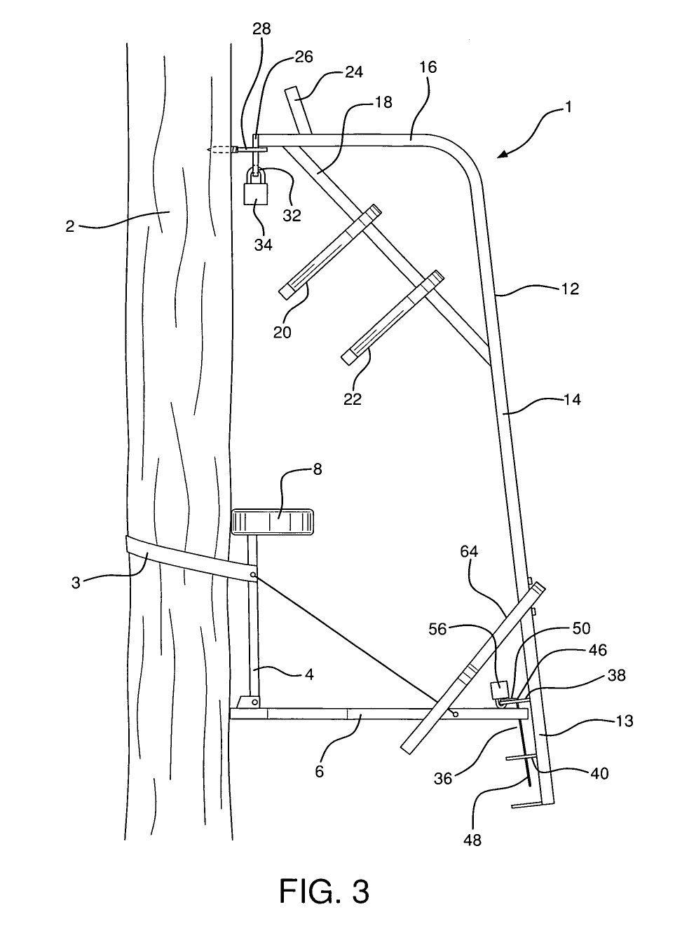

The vast majority of hang-on or chain-on type tree stands have supporting platforms with diamond shaped welded woven metal decking 60, as shown in FIG. 1. Attachment of bar member 12 to these platforms, with clasp system 36, using locking plate 46, rigidly secures the lower part of system 10. However, a small percentage of tree stands have parallel slot type platform 62, as shown in FIG. 2. The use only of clasp system 36 and its locking plate 46 will cause lateral movement of the lower section of bar member 12, in relation to platform 6. In such cases, this is remedied by the use of U-shaped locking bar 64, which is placed over bar member 12, straddling the sides of platform 6, as best seen in FIGS. 2 and 3. Locking bar 64 is secured to bar member 12 by bolt connection 66. With locking bar 64 so secured in place, movement of the lower section of bar member 12 in relation to platform 6 is eliminated and the bar member remains rigidly attached to the platform.

System 1 is easily removed from tree stand 4 by unlocking and withdrawing padlocks 34 and 56, removing locking plate 46 of clasp system 36 from the lower section of bar member 12, and lifting locking pad 26 out from the opening of cleat 28. If there is a desire to maintain system 1 in position adjacent to tree stand 4, while the tree stand is being used, only padlock 56 would need to be unlocked and withdrawn and locking plate 46 of clasp system 36 would be removed. Bar member 12 could then be swung laterally, to provide full, unencumbered use of tree stand 4.

The herein description discloses the use of system 1 of the present invention on one type of tree stand. However, it is contemplated that system 1 can be used on virtually any type of tree stand, including, but not limited to, single person, two person, chain-on, hang-on, and ladder tree stands.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A tree stand protection system for preventing the use of a tree supported tree stand having a user supporting platform, said system comprising:
barrier means for restricting the movement, activity, and vision of a user located on the tree stand, said barrier means being secured to the platform of the tree stand and extending from the platform towards the tree on which the tree stand is supported; and
means to lock the barrier means to the tree stand.

2. A tree stand protection system as in claim 1 wherein the means to lock secures the barrier means directly to the platform.

3. The tree stand protection system as in claim 2 wherein the means to lock further secures the barrier means directly to the tree.

4. The tree stand protection system as in claim 1 wherein the means to lock secures the barrier means directly to the tree.

5. The tree stand protection system as in claim 1 wherein the barrier means comprises an elongated bar member extending from the platform to the tree on which the tree stand is supported.

6. The tree stand protection system as in claim 5 wherein the barrier means further comprises a second bar member with at least one outstanding cross-bar transversely positioned on the second bar member.

7. The tree stand protection system as in claim 6 wherein the second bar member extends diagonally from the elongated bar member.

8. The tree stand protection system as in claim 5 further comprises an auxiliary bar member upstanding from the elongated bar member.

9. The tree stand protection system as in claim 1 further comprising bar locking means to restrain the barrier means from movement in relation to the platform of the tree stand.

10. The tree stand protection system as in claim 3 wherein the means to lock comprises a tree attached locking cleat and corresponding locking pad to secure the barrier means directly to the tree and a locking clasp to secure the barrier means directly to the platform.

11. The tree stand protection system as in claim 10 wherein the locking pad and locking clasp each comprise means to accept padlocks.

12. A tree stand protection system for preventing the use of a tree supported tree stand having a user supported platform, said system comprising:
an elongated bar member secured to the platform of the tree stand and extending from the platform to the tree on which the tree stand is supported;
a second bar member extending from the elongated bar member, said second bar member comprising at least one outstanding cross-bar transversely positioned on the second bar member; and
means to lock the elongated bar member to the tree stand.

13. The tree stand protection system as in claim 12 wherein the means to lock secures the elongated bar member directly to the platform.

14. The tree stand protection system as in claim 13 wherein the means to lock further secures the elongated bar directly to the tree.

15. The tree stand protection system as in claim 12 wherein the means to lock secures the elongated bar member directly to the tree.

16. The tree stand protection system as in claim 12 further comprising an auxiliary bar member upstanding from the elongated bar member.

17. The tree stand protection system as in claim 12 further comprising bar locking means to restrain the elongated bar member from movement in relation to the platform of the tree stand.

18. The tree stand protection system as in claim 12 wherein the second bar member extends diagonally from the elongated bar member.

19. The tree stand protection system as in claim 14 wherein the means to lock comprises a tree attached locking cleat and corresponding locking pad to secure the elongated bar member directly to the tree and a locking clasp to secure the elongated bar member directly to the platform.

20. The tree stand protection system as in claim 19 wherein the locking pad and locking clasp each comprise means to accept padlocks.
